(19) United States
(12) Patent Application Publication
(10) Pub. No.: US 2003/0101975 A1
(43) Pub. Date: Jun. 5, 2003

(54) Air-fuel ratio control apparatus of internal combustion engine and method thereof

(75) Inventors: Hidekazu Yoshizawa, Atsugi-shi (JP); Hajime Hosoya, Atsugi-shi (JP)

Correspondence Address: FOLEY AND LARDNER, SUITE 500, 3000 K STREET NW, WASHINGTON, DC, 20007, US

(73) Assignee: HITACHI UNISIA AUTOMOTIVE, LTD.

(21) Appl. No.: 10/305,167

(22) Filed: Nov. 27, 2002

(30) Foreign Application Priority Data
Nov. 29, 2001 (JP) 2001-364371
Dec. 5, 2001 (JP) 2001-371842
Dec. 5, 2001 (JP) 2001-371843
Dec. 5, 2001 (JP) 2001-371844

(51) Int. Cl. F02D 41/14

(52) U.S. Cl. 123/674; 701/109

(57) ABSTRACT

The present invention is constituted so that an actual air-fuel ratio is detected by an exhaust state by an air-fuel ratio sensor, parameters of transfer functions are calculated while sequentially identifying a plant model representing a plant between a fuel injection valve and the air-fuel ratio sensor by the transfer functions, a feedback control amount of said air-fuel ratio control signal is set using the parameters of the identified pant model, an offset correction amount of the air-fuel ratio control signal is set, and the plant model is identified using a valve obtained by adding the offset correction amount to the feedback control amount, and the actual air-fuel ratio.

### FIELD OF THE INVENTION

The present invention relates to an air-fuel ratio control technology for setting a feedback control amount to feedback control an air-fuel ratio, while calculating a parameter of a plant model representing a plant between a fuel injection valve and an air-fuel ratio sensor by a transfer function.

### DESCRIPTION OF THE RELATED ART

Heretofore, in an internal combustion engine, it is common to feedback control an air-fuel ratio to a target value so as to improve the exhaust purification and the fuel efficiency.

There has been disclosed a technique for performing such an air-fuel ratio feedback control with high accuracy (Japanese Unexamined Patent Publication No. 2001-164971), in which a waste time compensation control is performed by the Smith method, in an air-fuel ratio control apparatus of an internal combustion engine, for calculating a feedback control amount of a fuel injection quantity by a sliding mode control.

Such an air-fuel ratio control apparatus can be constituted such that a control gain of the sliding mode control is calculated by a self-tuning control. According to this air-fuel ratio control apparatus, the feedback control amount is computed as follows.

A plant model representing, by a transfer function, a plant between fuel injection means and air-fuel ratio detecting means is identified sequentially based on a fuel injection quantity and an actual air-fuel ratio.

Then, using this identified plant model (parameter), the entire system including the plant, a feedback control amount calculating section (in other words, a sliding mode control section) and a waste time compensation control section is represented by one transfer function, and a control gain of the sliding mode control is calculated so that a pole of the transfer function is coincident with a desirable pole from the point of view of response characteristic, overshoot, stabilization period, and so on.

Then, the feedback control amount of the fuel injection quantity is calculated by the sliding mode control utilizing the calculated control gain, to execute an air-fuel ratio control corresponding to a characteristic change in the plant with high accuracy.

However, it has been discovered that there is room for improvement in such an air-fuel ratio control, for example, how to process fixed offset correction values, such as air-fuel ratio learning value and water temperature correction value, different from the feedback control amount, and how to process a time of an open-loop control where no feedback control is performed, a time of fuel-cut, an a time of resuming the feedback control, and further, a case where the feedback control should not be performed even when the feedback control conditions are fulfilled.

### SUMMARY OF THE INVENTION

The present invention has been accomplished in view of the above problems and has an object to improve air-fuel ratio control performance of an internal combustion engine.

According to a first aspect of the present invention to achieve the above object, a basic constitution: to detect an actual air-fuel ratio by an air-fuel ratio sensor based on an exhaust state; to generate an air-fuel ratio control signal including a feedback control amount based on the actual air-fuel ratio at a time when a feedback control is performed; and to inject a fuel amount according to a target air-fuel ratio by a fuel injection valve that receives the air-fuel ratio control signal to be driven, is added with a constitution described below:

to calculate parameters of transfer functions, while sequentially identifying a plant model representing a plant between the fuel injection valve and the air-fuel ratio sensor by the transfer functions;

to set the feedback control amount of the air-fuel ratio control signal using the parameters of the identified plant model;

to set an offset correction amount of the air-fuel ratio control signal; and

to identify the plant model using a value obtained by adding the offset correction amount to the feedback control amount, and the actual air-fuel ratio.

According to a second aspect of the present invention a constitution described below is added to the above basic constitution:

to calculate parameters of transfer functions, while sequentially identifying a plant model representing a plant between the fuel injection valve and the air-fuel ratio sensor by the transfer functions;

to calculate a control gain for calculating the feedback control amount of the air-fuel ratio control signal using the parameters of the identified plant model;

to calculate the feedback control amount using the calculated control gain; and

to inhibit the calculation of the feedback control amount under a predetermined operating state other than the time when the feedback control is performed.

According to a third aspect of the present invention, constitution described below is added to the above basic constitution:

to calculate parameter of transfer functions, while sequentially identifying a plant model representing a plant between the fuel injection valve and the air-fuel ratio sensor by the transfer functions;

to calculate a control gain for calculating the feedback control amount of the air-fuel ratio control signal using the parameters of the identified plant model;

to calculate the feedback control amount using tie calculated control gain;

to store an air-fuel ratio control signal value and the actual air-fuel ratio at a time when an open-loop control is performed;

to stop the calculation of the plant model parameters at the time when an open-loop control is performed; and

to use the stored air-fuel ratio control signal value and actual air-fuel ratio as input/output data for the plant when the calculation of the plant model parameters is resumed after the open-loop control has been terminated.

According to a fourth aspect of the present invention, a constitution described below is added to the above basic structure:

to calculate parameters of transfer functions, while sequentially identifying a plant model representing a plant between the fuel injection valve and the air-fuel ratio sensor by the transfer functions;

to set the feedback control amount of the air-fuel ratio control signal by a sliding mode control based on the parameters of the identified plant model;

to judge whether or not a control direction of the feedback control amount and a change direction of the actual air-fuel ratio are coincident with each other; and

to inhibit the setting of the feedback control amount when the control direction of the feedback control amount and the change direction of the actual air-fuel ratio are not coincident with each other.

These and other objects and features of the present invention will become understood from the following description with reference to the accompanying drawings.

### BRIEF DESCRIPTION OF THE DRAWINGS

FIG. 1 is a diagram showing a hardware system common to embodiments of the present invention;

FIG. 2 is a block diagram showing an air-fuel ratio control of an internal combustion engine in a first embodiment;

FIG. 3 is a block diagram showing a waste time compensation control used in the first embodiment;

FIG. 4 is a table for calculating a waste time used in the first embodiment;

FIG. 5 is a block diagram representing, by transfer functions, an S/M control section 221 and waste time compensator 222 in the first embodiment;

FIG. 6 is a block diagram showing an overall air-fuel ratio feedback control by a sliding mode control using a self-tuning control in the first embodiment;

FIG. 7 is a block diagram showing an air-fuel ratio control of the internal combustion engine in a second embodiment;

FIG. 8 is a block diagram showing an air-fuel ratio control of the internal combustion engine in a third embodiment;

FIG. 9 is a block diagram showing an air-fuel ratio control of the internal combustion engine in a fourth embodiment;

FIG. 10 is a flowchart showing a control of a second feedback control amount calculation inhibiting section in the fourth embodiment; and

FIG. 11 is a block diagram showing an air-fuel ratio control of the internal combustion engine in a sixth embodiment,

### DETAILED DESCRIPTION OF THE PREFERRED EMBODIMENT

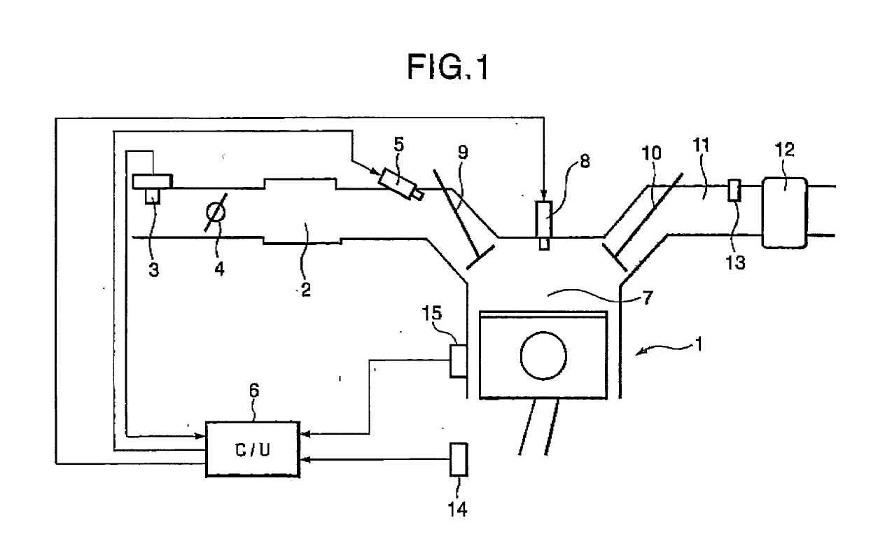

As shown in FIG. 1, an airflow meter 3 detecting an intake air amount Qa and a throttle valve 4 controlling the intake air amount Qa are provided to an intake passage 2 of an engine 1.

Further, a fuel injection valve 5 provided to intake passage 2 is driven to open by an injection signal from a control unit (C/U) 6 incorporating a microcomputer, to inject and supply fuel.

In each cylinder, an ignition plug 8 performing spark ignition within a combustion chamber 7 is disposed, to ignite an air-fuel mixture sucked in through an intake valve 9 by spark ignition.

Combustion exhaust is discharged via an exhaust valve 10 into an exhaust passage 11, and discharged to the atmosphere through an exhaust purifying apparatus 12.

A wide range air-fuel ratio sensor 13 detecting an air-fuel ratio linearly according to oxygen concentration within the exhaust is provided upstream of exhaust purifying apparatus 12 in exhaust passage 11.

Further, there are provided a crank angle sensor 14 outputting a crank angle signal at each predetermined crank angle of engine 1, and a water temperature sensor 15 detecting a cooling water temperature Tw within a cooling jacket of engine 1.

Control unit (C/U) 6 controls fuel injection valve 5 in the following manner.

First, a basic fuel injection quantity Tp=K×Qa×Ne (wherein K is constant) corresponding to a stoichiometric air-fuel ratio (λ=1) is calculated from the intake air amount Qa and an engine rotation speed Ne detected based on the signal from crank angle sensor 14.

Next, it is judged whether the air-fuel ratio is to be feedback controlled or open-loop controlled, according to operating conditions. When the air-fuel ratio is to be feedback controlled, a final fuel injection quantity Ti=Tp×(1/λt)×t(α+αL+COEF) is calculated using the basic fuel injection quantity Tp, a target air-fuel ratio λt, and also an air-fuel ratio feedback correction coefficient α, an air-fuel ratio learning value αL and various coefficients COEF calculated based on the detection signals from air-fuel ratio sensor 13.

In the case where the air-fuel ratio is to be open-loop controlled, the air-fuel ratio feedback correction coefficient α is fixed to 1 (α=1), to calculate the final fuel injection quantity Ti.

Now, a fuel injection control in a first embodiment will be described.

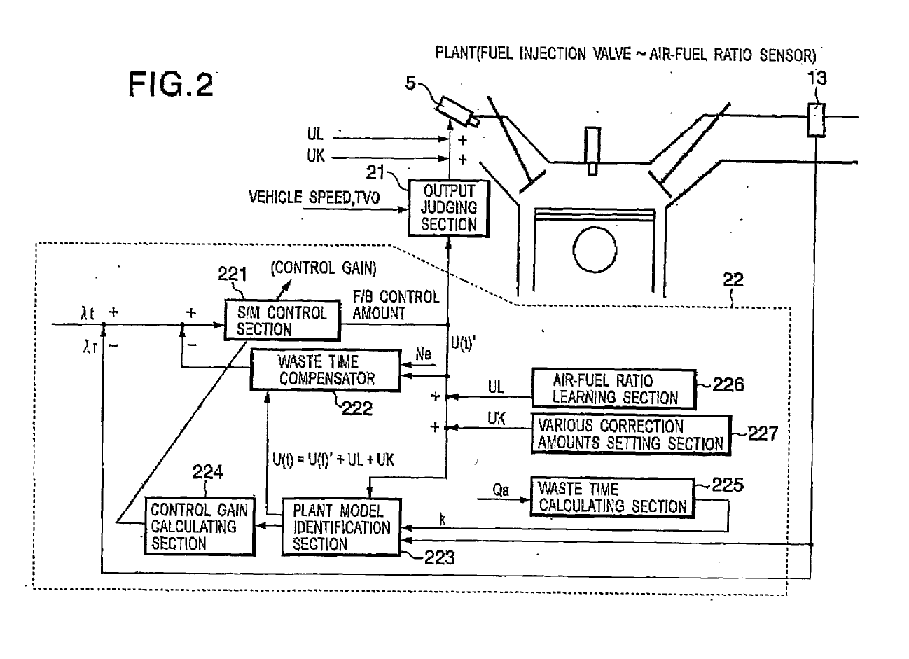

As shown in FIG. 2, a fuel injection control section in the present embodiment comprises an output judging section 21 judging an output to fuel injection valve 5, and an air-fuel ratio feedback control section 22 shown by dashed lines in the figure.

Output judging section 21 judges whether or not a feedback correction amount calculated by air-fuel ratio feedback control section 22 is to be to output to fuel injection valve 5, according to operating conditions. When the feedback control amount is not to be output, then a damp value (1 at the time when the open-loop control is performed, 0 at a time when fuel is cut off) is output as the feedback control amount.

Air-fuel ratio feedback control section 22 comprises a sliding mode control section (S/M control section) 221, a waste time compensator 222, a plant model identification section 223, a control gain calculating section 224, a waste time calculating section 225, an air-fuel ratio learning section 226, and a various correction amounts setting section 227.

S/M control section 221 calculates a control amount u(t) for a plant (between fuel injection valve 5 and air-fuel ratio sensor 13). In other words, the feedback control amount of fuel injection valve 5 (air-fuel ratio feedback correction coefficient α), according to the following equation (1), by the sliding mode control, based on a deviation between the target air-fuel ratio λt and the actual air-fuel ratio λt.

$$u ( t ) = {K}_{ρ} \cdot e ( t ) + {K}_{D} \cdot Δ e ( t ) + {K}_{i} \cdot \sum σ ( t ) + {K}_{N} \cdot \frac{σ ( t )}{\vert σ ( t ) \vert} \qquad ( 1 )$$

wherein e(t) is an input to S/M control section 221 (target air-fuel ratio—actual air-fuel ratio), K_{P} is a linear term linear gain, K_{D} is a linear term derivative gain, Sₚ is a switching function linear gain, S_{D} is a switching function derivative gain, Kₜ is an adaptive law gain, K_{N} is a nonlinear gain, and σ(t) is a switching function, wherein σ(t)=S_{P}e(t)+S_{D}Δe(t).

Note, each control gain is calculated at control gain calculating section 224 mentioned later.

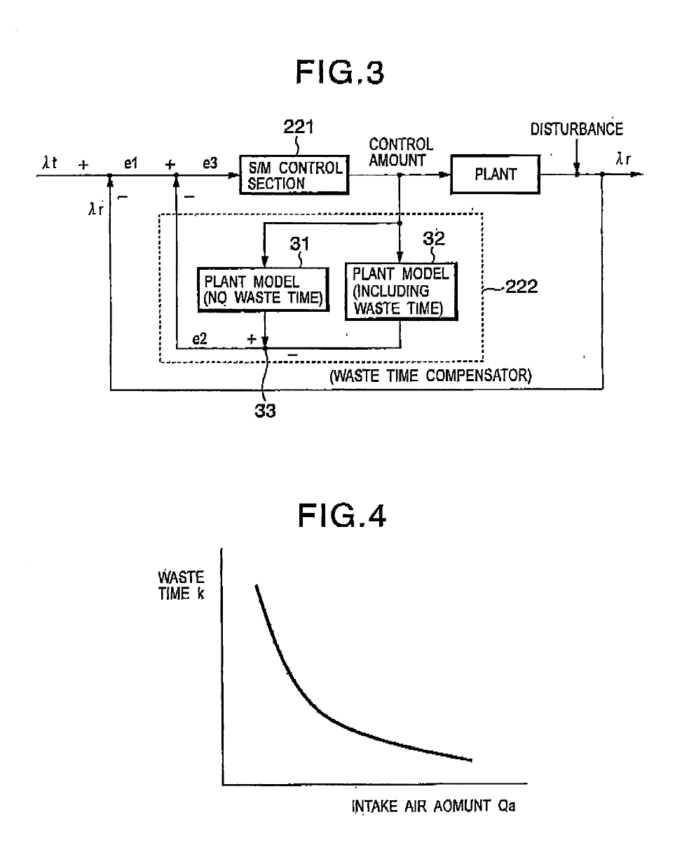

Waste time compensator 222 is for executing a waste time compensation control by a Smith method, and compensates for an influence of waste time (that is, a phase delay of detected air-fuel ratio) included in the plant by performing a local feedback. Specifically, as shown in FIG. 3, waste time compensator 222 comprising a plant model 31 including no waste time, a plant model 32 including a waste time k and a subtraction section 33, calculates a deviation e2 between an output (air-fuel ratio) prediction calculated at plant model 31 including no waste time element and an actual output (actual air-fuel ratio) prediction calculated at plant model 32 including waste time, to output the deviation e2 to an input side of S/M control section 221.

Then, e3 is calculated by subtracting e2 output from waste time compensator 222 from a deviation e1 between the target air-fuel ratio λt and the actual air-fuel ratio λr, to be input to S/M control section 221.

The above plant model is identified at plant model identification section 223 described later, and the waste time k is calculated at waste time calculating section 225 also described later.

Plant model identification section 223 identifies on-line the plant model representing the plant by a transfer function based on the fuel injection quantity (fuel injection signal) and the actual air-fuel ratio (output). Specifically, a recursive least squares method (RLS method) Is used to perform a recursive calculation of plant model parameter.

Control gain calculating section 224 calculates the control gain of S/M control section 221 using the parameter of the plant model identified by plant model identification section 223.

Specifically, the self-tuning control by a pole assignment method is used to represent, by a closed-loop transfer function, an entire system (in other words, plant (between fuel injection valve 5 and air-fuel ratio sensor 13)+S/M control section 221+waste time compensator 222), to calculate the control gain of S/M control section 221 so that a pole of the closed-loop transfer function is coincident with a desirable pole from the point of view of response characteristic, overshoot, stabilization period, and so on (details of which will be described later).

Waste time calculating section 225 calculates the waste time k included in the plant. Such calculation of waste time k is performed, for example, by preparing in advance a table illustrating a relation between the intake air amount Qa and the waste time k, as shown in FIG. 4, and by retrieving the table based on the detected intake air amount Qa.

Air-fuel ratio learning section 226 learns a deviation between the feedback control amount and a reference value caused by degradation or variations of parts of the air-fuel ratio control system. Specifically, a deviation Δα between the reference value (α0=1) and a value obtained by weighted averaging values resulted from a plurality of samplings of the feedback control amount u(t) being the air-fuel ratio feedback correction coefficient α is calculated, and a predetermined ratio of deviation Δα (<1) is calculated as a learning value UL, to be updated in a RAM.

Various correction amounts setting section 227 sets various correction amounts UK such as a water temperature correction coefficient based on a detected water temperature value.

Then, according to a characteristic constitution of the present invention, the learning value UL learned at air-fuel ratio learning section 226 and various correction amounts UK set at various correction amounts setting section 227 are added to the feedback correction amount u(t)′ output from S/M control section 221, and the added value is input as a control input u(t)[=u(t)′+UL+UK] to plant model identification section 223.

Now, the calculation of the control gain performed at control gain calculating section 224 will be described in detail.

The control gain calculation using the self-tuning control by the pole assignment method is performed a follows.

First, a plant model G_{P}(z⁻¹) representing the plant by the transfer function is set. Thereafter, a transfer function G_{C}(z⁻¹) of S/M control section 221 and a transfer function G_{L}(z⁻¹) of waste time compensator 222 are obtained.

Then, based on these transfer functions, a closed-loop transfer function W(z⁻¹) of the entire system is calculated, and the control gain is calculated so that a pole of the closed-loop transfer function becomes a set pole.

(A) Setting of Plant Model

The plant between fuel injection valve 5 and air-fuel ratio sensor 13 is expressed by a quadratic ARX model A(z⁻¹), for example, as in the following equations (2) and (3), using the waste time k(≧1) calculated at waste time calculating section 225.

A(z⁻¹)y(t)=z^{-k}b₀u(t)+ε(t) (2)

A(z⁻¹)=1+a₁z⁻¹+a₂z⁻² (3)

wherein y(t) is a plant output (that is, actual air-fuel ratio), u(t) is a plant input value (that is, fuel injection quantity), and ε(t) is a random noise.

Then, the transfer function G_{P}(z⁻¹) of the plant model can be expressed by the following equation (4).

G_{P}(z⁻¹)=z^{-k}b₀/A(z⁻¹) (4)

Further, a calculation parameter vector θ(t) and a data vector ψ(t−k) can be expressed by the following equations (5) and (6).

θ(t)=[a₁(t),a₂(t),b₀(t)]^{T} (5)

ψ(t−k)=[−y(t−1),−y(t−2),u(t−k)]^{T} (6)

(B) Identification (Parameter Calculation) of Plant Model

The set plant model is identified at plant model identification section 223.

Specifically, a characteristic of the plant is changed according to operating conditions and plant characteristic such as the degradation of the plant itself, so the plant model is identified (by online identification) by sequentially calculating input parameters a₁(t), a₂(t) and an output parameter b₀(t) shown in the equation (5).

Further, in the present embodiment, the recursive least squares method (RLS method) is used to calculate the above parameters, and parameters in which the square of an error between an actual value and a calculated value becomes minimum are sequentially calculated.

A specific calculation is the same as a general weighted recursive least squares method (RLS method), and is performed by calculating the following equations (7) through (9) with respect to a time update equation; t=1, 2, . . . , N.

$$\begin{matrix}\hat{θ} ( t ) = \hat{θ} ( t - 1 ) + \frac{P ( t - 1 ) Ψ ( t - k )}{1 + {Ψ}^{T} ( t - k ) P ( t - 1 ) {Ψ ( t - k )}^{E ( t )}} & ( 7 ) \\ ϵ ( t ) = y ( t ) - {Ψ}^{T} ( t - k ) \hat{θ} ( t - 1 ) & ( 8 ) \\ P ( t ) = \frac{1}{{λ}_{1}} [ P ( t - 1 ) - \frac{{λ}_{2} P ( t - 1 ) Ψ ( t - k ) {Ψ}^{T} ( t - k ) P ( t - 1 )}{{λ}_{1} + {λ}_{2} Ψ ( t ) {Ψ}^{T} ( t - k ) P ( t - 1 ) Ψ ( t - K )} ] & ( 9 )\end{matrix}$$

wherein

\hat{θ}(t): parameter estimation value (parameter prediction value)

ε(t): prediction error (actual value−prediction value)

P(t): m×m matrix constituted of input/output (covariance matrix)

ψ(t): input/output value (data vector)

λ₁, λ₂: forgetting coefficient,

moreover, an initial value of parameter estimation: \hat{θ}(0)=θ0

an initial value of covariance matrix P(0)=α·I wherein α=1000 (I represents unit matrix).

Then, by sequentially calculating parameters a₁(t), a₂(t), and b₀(t) using the parameter calculation equations (7) through (9), the plant model is identified.

Note, as for forgetting coefficients λ₁, λ₂, when there exists no forgetting element, λ₁=λ₂=1, while when there exists a forgetting element, λ₁=0.98 and λ₂=1.

Moreover, in the present embodiment, as the initial value θ0 of the parameter calculation value, an initial value preset according to operating conditions (for example, a₁(0)=A1, a₂(0)=A2, and b₀(0)B1) is set, so as to shorten a time until convergence

(C) Calculation of a Discrete Time Transfer Function of S/M Control Section 221

S/M control section 221 is made to be a transfer function according to the following procedure.

It is assumed that y(t) is a plant output (actual air-fuel ratio λr), w(t) is a target value (target air-fuel ratio λt), and e(t)=ω(t)−y(t), a difference Δu(t) of the plant input u(t) of one sample (in other words, the output from S/M control section 221) can be calculated by the following equation (10).

$$\begin{matrix}Δ u ( t ) = u ( t ) - u ( t - 1 ) \\ = {K}_{p} Δ e ( t ) + \underbrace{{K}_{D} Δ \{ Δ e ( t ) \} + {K}_{j}}_{( linear term deviation )} \{ \underbrace{{S}_{p} \overbrace{e ( t ) + {S}_{D} Δ e ( t )}^{( switching function )}}_{( adaptive law )} \} + \underbrace{{K}_{N} \frac{σ ( t )}{\vert σ ( t ) \vert}}_{( nonlinear term deviation )} \\ = {K}_{p} \{ e ( t ) - e ( t - 1 ) \} + {K}_{D} {\{ e ( t ) - e ( t - 1 ) \}}^{2} + {K}_{j} {S}_{p} e ( t ) + {K}_{j} {S}_{D} \{ e ( t ) - e ( t - 1 ) \} + {K}_{N} ( \frac{σ ( t )}{\vert σ ( t ) \vert} - \frac{σ ( t - 1 )}{\vert σ ( t - 1 ) \vert} ) \\ \end{matrix} \qquad ( 10 )$$

wherein e(t)=ω(t)−y(t), e(t)−e(t−1)=Δe(t), so the following equation (11) is obtained from the equation (10).

$$( 1 - {z}^{- 1} ) u ( t ) = K ( {z}^{- 1} ) \{ ω ( t ) - y ( t ) \} + {K}_{N} ( 1 - {z}^{- 1} ) \frac{σ ( t )}{\vert σ ( t ) \vert} \qquad ( 11 )$$

where K(z⁻¹) is represented by the following equation (12), which is expanded as the equation (13) to be calculated based on each control gain.

K(z⁻¹)=K_{P}(1−z⁻¹)+K_{D}(1−z⁻¹)²+K_{I}S_{P}+K_{I}S_{D}(1−z⁻¹) (12)

(K_{P}+K_{I}S_{P}+K_{I}S_{D}+K_{D})−(K_{P}+K_{I}S_{D}+2K_{D})z⁻¹+K_{D}z⁻² (13)

Accordingly, from the equation (12), the plant input u(t) can be expressed by the following equation (14).

$$u ( t ) = \frac{K ( {z}^{- 1} )}{1 - {z}^{- 1}} \{ ω ( t ) - y ( t ) \} + {K}_{N} ( 1 - {z}^{- 1} ) \frac{σ ( t )}{\vert σ ( t ) \vert} \qquad ( 14 )$$

Here, if the calculation is performed so as not to include the nonlinear term, the discrete time transfer function G_{c}(z⁻¹) of S/M control section 221 can be expressed by the following equation (15).

G_{c}(z⁻¹)=K(z⁻¹)/(1−z⁻¹) (15)

(D) Calculation of a Discrete Time Transfer Function of Waste Time Compensator 222

As described above, waste time compensator 222 uses the Smith method that compensates for the influence of was time element while performing the output prediction after waste time, so a discrete time transfer function G_{L}(z⁻¹) of waste time compensator 222 can be calculated by the following equation (16),

G_{L}(z⁻¹)=z⁻¹b₀/A(z⁻¹)−z^{-k}b₀/A(z⁻¹)=(z⁻¹−z^{-k})b₀/A(z⁻¹) (16)

Note, z⁻¹b₀/A(z⁻¹) is an output prediction including no waste time expressed using the plant model, and z^{-k}b₀/A(z⁻¹) is an actual output prediction including waste time expressed using the plant mode.

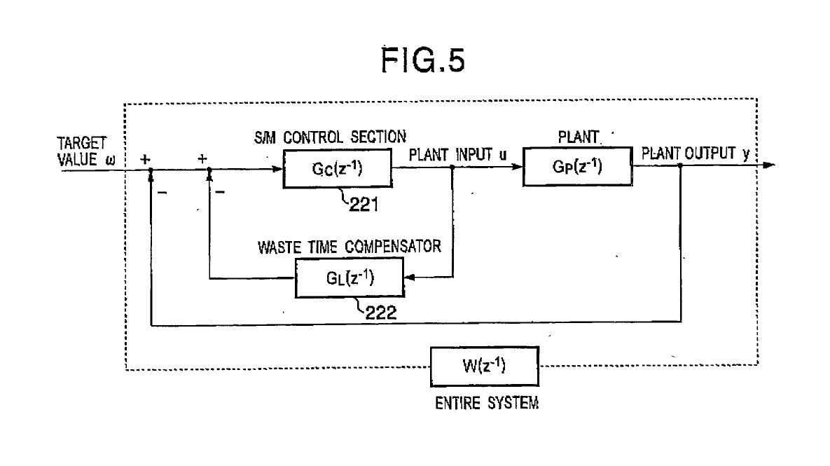

FIG. 5 is a block diagram using the respective transfer functions (plant model, S/M control section 21, waste time compensator) calculated as described above.

Next, mere will be described a method of making the entire system to be a closed-loop transfer function.

As described above, the nonlinear term of S/M control section 221 is not included.

(E) Calculation of a Closed-Loop Transfer Function W(z⁻¹) of the Entire System

At first, a feedback loop of S/M control section 221 and waste time compensator 222 is taken out to calculate one transfer function from a target (target air-fuel ratio λt) to an output (feedback control amount). In FIG. 5, a transfer function G_{CL}(z⁻¹) of the local loop including S/M control section 221 and waste time compensator 222 can be calculated as the following equation (17) based on the equations (15) and (16).

$$\begin{matrix}{G}_{C L} ( {z}^{- 1} ) = \frac{{G}_{C} ( {z}^{- 1} )}{1 + {G}_{L} ( {z}^{- 1} ) \cdot {G}_{C} ( {z}^{- 1} )} \\ = \frac{\frac{K ( {z}^{- 1} )}{1 - {z}^{- 1}}}{1 + {G}_{L} ( {z}^{- 1} ) \cdot \frac{K ( {z}^{- 1} )}{1 - {z}^{- 1}}} \\ = \frac{K ( {z}^{- 1} )}{( 1 - {z}^{- 1} ) + {G}_{L} ( {z}^{- 1} ) K ( {z}^{- 1} )}\end{matrix} \qquad ( 17 )$$

Accordingly, the closed-loop transfer function W(z⁻¹) of the entire system including the local loop shown in equation (17) and the plant can be calculated by me following equation (18).

$$\begin{matrix}W ( z ) = \frac{{G}_{C L} ( {z}^{- 1} ) \cdot \frac{{z}^{- k} {b}_{0}}{A ( {z}^{- 1} )}}{1 + {G}_{C L} ( {z}^{- 1} ) \cdot \frac{{z}^{- k} {b}_{0}}{A ( {z}^{- 1} )}} \\ = \frac{K ( {z}^{- 1} ) {z}^{- k} {b}_{0}}{\{ ( 1 - z ) + {G}_{L} ( {z}^{- 1} ) K ( {z}^{- 1} ) \} \cdot A ( {{z}^{-}}^{1} ) + K ( {z}^{- 1} ) {z}^{- k} {b}_{0}} \\ = \frac{K ( {z}^{- 1} ) {z}^{- k} {b}_{0}}{( 1 - {z}^{- 1} ) A ( {{z}^{-}}^{1} ) + K ( {z}^{- 1} ) \{ {z}^{- 1} {b}_{0} - {z}^{- k} {b}_{0} \} + K ( {z}^{- 1} ) {z}^{- k} {b}_{0}} \\ = \frac{K ( {z}^{- 1} ) {z}^{- k} {b}_{0}}{( 1 - {z}^{- 1} ) A ( {{z}^{-}}^{1} ) + {z}^{- 1} {b}_{0} K ( {z}^{- 1} )}\end{matrix} \qquad ( 18 )$$

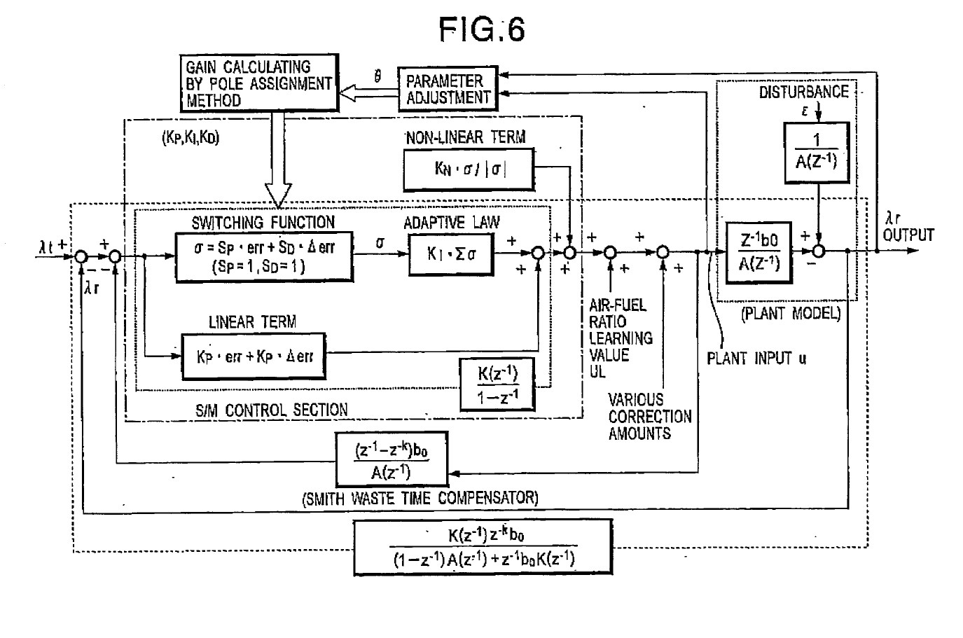

FIG. 6 is a block diagram showing the result of the above calculation.

(F) Calculation of the Control Gain of S/M Control Section 222 by the Pole Assignment Method

From the equation (18), the characteristic polynomial of closed-loop transfer function W(z⁻¹) is:

(1−z⁻¹)A(z⁻¹)+z⁻¹b₀K(z⁻¹),

and the above is adopted in the following equation (19).

(1−z⁻¹)A(z⁻¹)+z⁻¹b₀K(z⁻¹)=T(z⁻¹)=1+t₁z⁻¹+t₂z⁻² (19)

At this time, by setting T(z⁻¹) to achieve the desired pole from the point of view of response characteristic, overshoot, stabilization period, and so on, the control gain of S/M control section 221 is calculated as follows.

The following equation (20) is obtained from the equation (19).

$$\begin{matrix}K ( z ) = \frac{1 + {t}_{1} {z}^{- 1} + {t}_{2} {z}^{- 2} - ( 1 - {z}^{- 1} ) A ( {z}^{- 1} )}{{z}^{- 1} {b}_{0}} \\ = \frac{1 + {t}_{1} {z}^{- 1} + {t}_{2} {z}^{- 2} - \{ 1 + ( {a}_{1} - 1 ) {z}^{- 1} + ( {a}_{2} - {a}_{1} ) {z}^{- 2} - {a}_{2} {z}^{- 3} \}}{{z}^{- 1} {b}_{0}} \\ = \frac{( {t}_{1} - {a}_{1} + 1 ) + ( {t}_{2} - {a}_{2} + {a}_{1} ) {z}^{- 1} + {a}_{2} {z}^{- 2}}{{b}_{0}}\end{matrix} \qquad ( 20 )$$

Here, based on the equation (13),

K(z⁻¹)=(K_{P}+K_{I}S_{P}+K_{I}S_{D}+K_{D})−(K_{P}+K_{I}S_{D}+2K_{D})z⁻¹+K_{D}Z².

So, by setting the switching function linear gain S_{P} and switching function derivative gain S_{D} to 1, and setting the linear term linear gain K_{P}, adaptive law gain K_{I} and linear term derivative gain K_{D} as variable parameters, the following equation (21) can be obtained.

$$\begin{matrix}( {K}_{p} + S {K}_{1} + {K}_{D} ) - ( {K}_{p} + {K}_{L} + 2 {K}_{D} ) {z}^{- 1} + {K}_{D} {z}^{- 2} = & ( 21 ) \\ \frac{( {t}_{1} - {a}_{1} + 1 ) + ( {t}_{2} - {a}_{2} + {a}_{1} ) {z}^{- 1} + {a}_{2} {z}^{- 2}}{{b}_{0}} & \end{matrix}$$

Then, the following equations (22) through (24) are obtained.

$$\begin{matrix}( {K}_{P} + 2 {K}_{I} + {K}_{D} ) = \frac{{t}_{1} - {a}_{1} + 1}{{b}_{0}} & ( 22 ) \\ - ( {K}_{P} + {K}_{I} + 2 {K}_{D} ) = \frac{{t}_{1} - {a}_{2} + {a}_{1}}{{b}_{0}} & ( 23 ) \\ {K}_{D} = \frac{{a}_{2}}{{b}_{0}} & ( 24 )\end{matrix}$$

Therefore, by solving the equations (22) through (24) for K_{P}, K_{I} and K_{D}, respectively, and expressing a₁, a₂ and b₀ by calculation parameters a₁(t), a₂(t) and b₀(t) sequentially calculated by plant model identification section 223, respectively, each gain can be calculated by the following equations (25) through (27), respectively.

$$\begin{matrix}{K}_{P} = \frac{1 + {t}_{1} + 2 {t}_{2} + {a}_{1} ( t ) + {a}_{2} ( t )}{{b}_{0} ( t )} & ( 25 ) \\ {K}_{I} = \frac{1 + {t}_{1} + {t}_{2}}{{b}_{0} ( t )} & ( 26 ) \\ {K}_{D} = \frac{{a}_{2} ( t )}{{b}_{0} ( t )} & ( 27 )\end{matrix}$$

Further, for the characteristic polynomial T(z⁻¹)=1+t₁z⁻¹+t₂z⁻², it is possible to consider the use of the denominator of the transfer function of when the quadratic continuous lime system

G(s)=ω²/(s²+2ζωs+ω²)

is made to be discrete by a sample time Ti, wherein attenuation ζ=0.7 and natural angular frequency ω=30.

Then, by using the so-calculated control gain, S/M control section 221 calculates the control amount for the plant (refer to the equation (13)).

As described above, the entire system is expressed with a single transfer function using the plant model obtained by sequentially calculating parameters, and the control gain of S/M control section 221 calculating the feedback control amount for the plant is obtained so that the pole of the transfer function is coincident with the desirable pole from the point of view of response characteristic, overshoot, stabilization period and so on. Thus, a good control gain corresponding well to the characteristic change of the plant can be calculated, and as a result, an accurate air-fuel ratio feedback control can be executed.

Here, even in the above described air-fuel ratio control system, similar to a general air-fuel ratio feedback control, ft is desirable to learn a deviation of the feedback control amount from a reference value due to deterioration with time and the like of parts. If such learning is not performed, a correction that should have been corrected by the learning is absorbed by the plant model identification. Such plant model identification is not the one adapted to actual operating conditions, wherein parameter values of plant model to be identified are greatly changed due to a change in operating conditions, making it impossible to perform a stable feedback control.

Thus, even in the above described air-fuel ratio control system, it is desirable to apply the air-fuel ratio learning, but it has been discovered that the application of the air-fuel ratio learning as in the conventional method causes the following problems. That is, when the operating conditions are changed and the learning value is switched to a learning value of a new operating region that is, the learning in which the learning value of the new operating region is an initial value), in the data input to the identification section of the plant model, the actual air-fuel ratio on me output side detected by the air-fuel ratio sensor is a value reflecting the learning value but the feedback control amount on the input side of the fuel injection quantity is unchanged. Therefore, the plant model identification is not performed correctly. As a result, the control gain based on the parameter obtained by the identification cannot be adopted, and thus it becomes impossible to obtain good air-fuel ratio feedback control performance.

The same applies for the water temperature based correction and the like, other than the learning. Even if the feedback correction amount not reflected by the correction and the actual air-fuel ratio reflected by the correction are input to identify the plant model (parameter calculation), it is impossible to perform the satisfactory identification.

Therefore, in the present embodiment, since the air-fuel ratio learning value UL and the various correction amounts UK are added to the feedback control amount u(t) output from S/M control section 221, to be input to plant model identification section 223, it is possible to compare the control input and control output with each other under the same conditions, to identify the plant model or calculate the parameter.

As a result, the parameter satisfactorily adapted to the actual condition can De obtained to calculate the feedback control amount with high accuracy, and even when the learning value to be used is switched or various correction amounts are changed due to the change in operating conditions, the air-fuel ratio feedback control can be performed stably with high accuracy.

Now, a second embodiment of the present invention will be described.

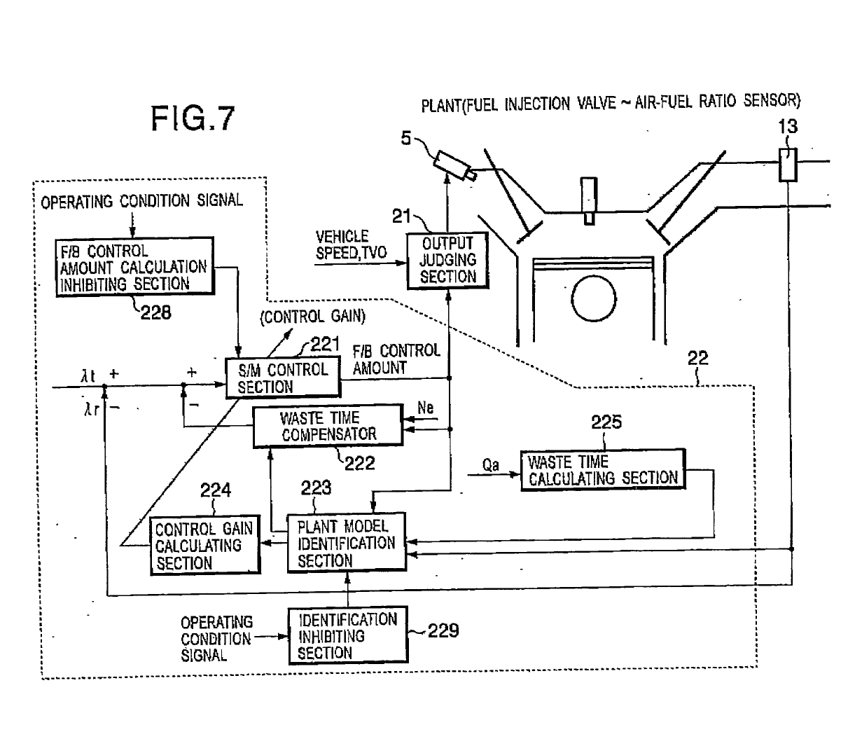

In FIG. 7 showing the air-fuel ratio control function of the present embodiment, air-fuel ratio feedback control section 22 includes a feedback control amount calculation inhibiting section 228.

Feedback control amount calculation inhibiting section 228 inhibits the calculation (update) of the feedback control amount by sliding mode control section (S/M control section) 221 calculating the feedback control amount under predetermined operating conditions, specifically, at the time when the open-loop control where the air-fuel ratio feedback correction coefficient α is fixed to 1 (α=1) and the time when the fuel is cut off. The fulfillment of such conditions where the open-loop control or the fuel cut are executed is detected for example by verifying the drive signal from fuel injection valve 5 or a flag (fuel cut off flag).

The reason why the calculation of feedback control amount is inhibited is that, if the calculation of feedback control amount is continued even at the open-loop control time where the feedback control is not performed that is, the feedback control amount calculated at S/M control section 291 is not output to fuel injection valve 5), or at the fuel cut off tine, the integral term (calculated based on error amount=target air-fuel ratio—actual air-fuel ratio) in the sliding mode control is increased, and thereafter, when the feedback control is resumed, an appropriate fuel injection control cannot be performed.

Then, after the open-loop control or the fuel cut off is terminated, the feedback control (that is, the calculation of feedback control amount by S/M control section 221) is resumed. In the present embodiment, an initial value previously set cording to operating conditions is set to the integral term in the sliding mode control at the time of resumption.

Thus, the integral term in the sliding mode control is reset by the initial value previously set according to operating conditions when the feedback control is resumed, so that an appropriate feedback control amount can be output to fuel injection valve 5 immediately after the feedback control is resumed.

Even further, the above described initial value may be maintained for a predetermined period of time after resumption of the feedback control, considering a response delay after the resumption.

Thereby, a more appropriate feedback control amount can be output to fuel injection valve 5 since the calculation of the integral term is not performed during the response delay.

It is also possible to consider the execution of open-loop control as being equal to not calculating the feedback control amount (that is, inhibiting thereof), but even in such a case, it is possible to secure the appropriate fuel injection control after the resumption of the feedback control, by setting the previously set initial value according to operating conditions to the integral term in the sliding mode control when the feedback control is resumed, and maintaining this initial value for a predetermined period of time.

Further, as shown in FIG. 7, an identification inhibiting section 229 is preferably provided for inhibiting the identification of the plant mode (parameter estimation) at the open-loop control time and at the fuel cut off time, similar to the inhibition of the calculation of the feedback control amount by S/M control section 221.

That is, at the feedback control time, the fuel injection is controlled by the feedback control amount calculated by S/M control section 221, but at the open-loop control time or at the fuel cut off time, a value different from the feedback control amount calculated by S/M control section 221 is output to fuel injection valve 5. Therefore, a plant state prediction (plant model identification) completely different from that performed at the feedback control time is performed. Under such circumstances, there is no sense in performing the plant state prediction in order to calculate the feedback control amount, leading to incorrect identification results (deterioration of the identification accuracy of the plant model).

In order to prevent such deterioration of the identification accuracy (parameter estimation accuracy), the plant model identification is inhibited when the feedback control is not performed.

In this case, the calculation of the control gain by control gain calculating section 224 is also not performed correctly, so the calculation of the control gain may similarly be inhibited.

The identification of the plant model is resumed when the feedback control is resumed (if the calculation of the control gain is also inhibited, the calculation thereof is also resumed). At the time of the resumption of identification, the initial value θ0 (A1, A2, B1) previously set according to operating conditions is used as the parameter of the plant model.

Thus, by resetting the parameter value used immediately before inhibiting the identification by the initial value θ0 (A1, A2, B1), it is possible to maintain the identification accuracy after the resumption of identification at a high level without considering the change in the plant characteristic before and after inhibiting the identification, and also to shorten the convergence time.

Further, the set initial value (parameter A1, A2, B1) is maintained for a predetermined period of time after the resumption of identification.

This is because, nut only immediately after the resumption of identification but also for a predetermined period of time immediately after the resumption of identification, due to the response delay, an air-fuel ratio corresponding to the feedback control amount calculated by S/M control section 221 cannot be detected, and therefore, it is impossible to obtain a correct identification result, similar to the case other than the feedback control time.

As described, in the present embodiment at the open-loop control time and at the fuel cut off time, the calculation of the feedback control amount by S/M control section 221 is inhibited and also the estimation of the parameter by plant model identification section 223 is inhibited, so that the calculation of erroneous result can be prevented in advance so as to execute an appropriate fuel injection control at the time of resumption of the feedback control, leading to an accurate air-fuel ratio control.

Next, a third embodiment of the present invention will be described.

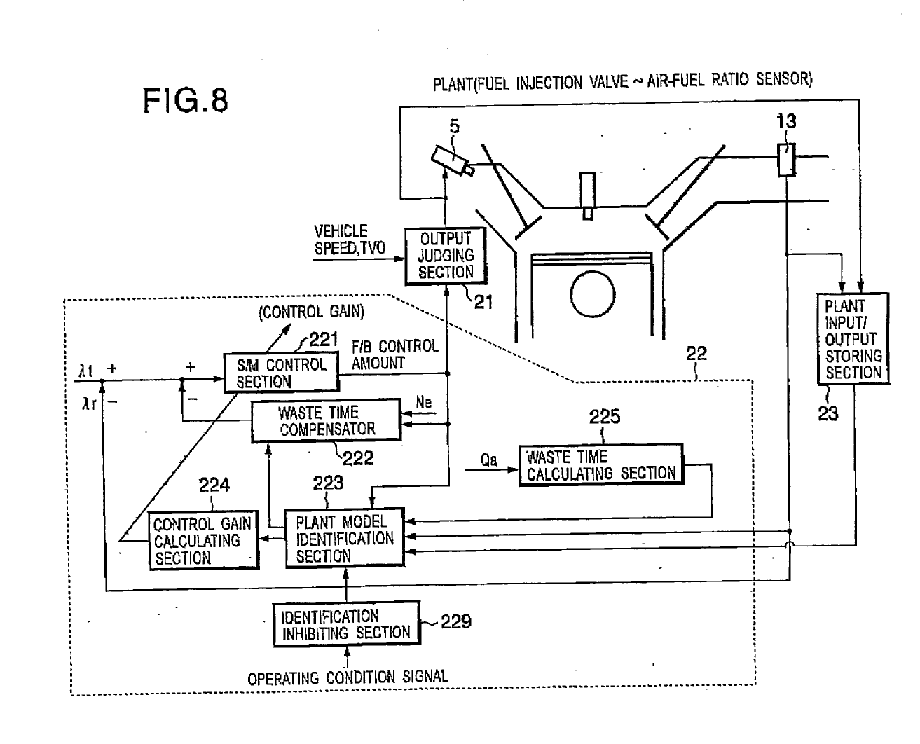

FIG. 8 shows the air-fuel ratio control function according to the present embodiment, wherein identification inhibiting section 229 shown in the second embodiment is included in air-fuel ratio feedback control section 22, and a plant input/output storing section 23 is provided.

Plant input/output storing section 23 stores the control amount (that is, α=1) and the dented air-fuel ratio at the open-loop control time (that is, when output judging section 21 outputs 1 as the control amount).

Similar to the second embodiment, the plant model identification is inhibited at the open-loop control time and at the fuel cut off time by identification inhibiting section 229. However, when the open-loop control is terminated, and the plant model identification is resumed as well as the and feedback control, the control amount and the air-fuel ratio stored in plant input/output storing section 23 are set as input/output data of the plant.

Even if the feedback control is resumed, the actual air-fuel ratio detected during a period of time from the resumption until the lapse of waste time k of the plant, does not correspond to the feedback control amount calculated by S/M control section 221 but to that at the open-loop control time. Therefore, if the plant model identification is performed based on such uncorrelated input/output data, the identification accuracy is greatly deteriorated.

Accordingly, not only at the time of resumption of the feedback control but also during the period of time from the resumption until the lapse of waste time k of the plant, the control amount and the air-fuel ratio at the open-loop control time stored in plant input/output storing section 23 are used as input/output data of the plant, to identify the plant model.

Thus, it is possible to shorten the convergence of the plant model parameter after the resumption of the feedback control while preventing incorrect identification (parameter estimation).

As a result, even after resuming the feedback control, it is possible to calculate a good control gain corresponding well to the characteristic change of plant at an early period, to thereby execute a highly accurate air-fuel ratio feedback control.

Next, a fourth embodiment of the present invention will be described.

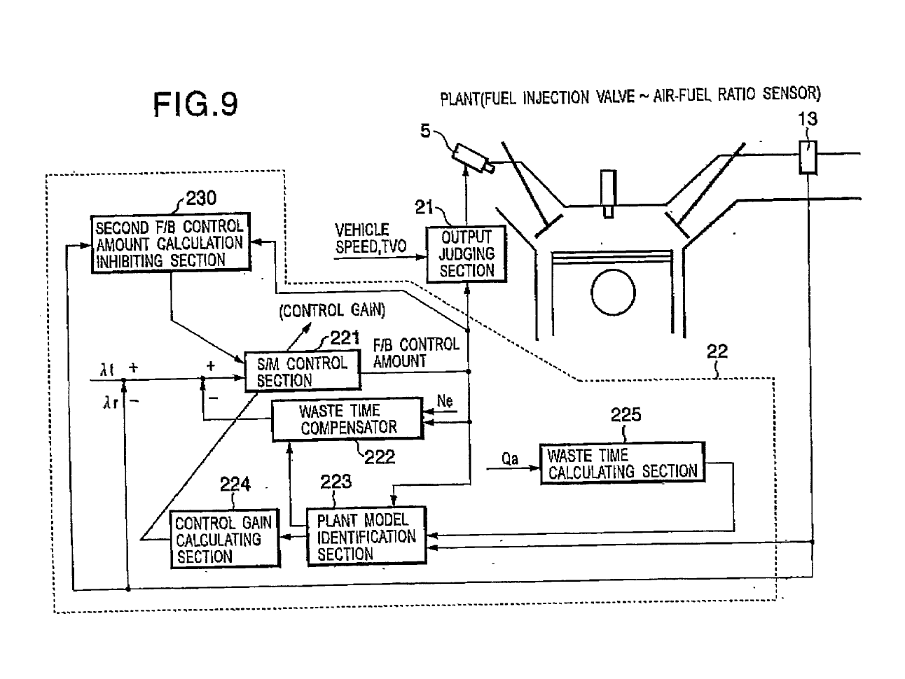

FIG. 9 shows the air-fuel ratio control of the present embodiment, wherein air-fuel ratio feedback control section 22 includes a second feedback control amount calculation inhibiting section 230.

Second feedback control amount calculation inhibiting section 230 inhibits the setting of feedback control amount when a control direction (an increase/decrease direction of air-fuel ratio) and a change direction of the actual air-fuel ratio are not coincident with each other in the case where the waste time is not adapted.

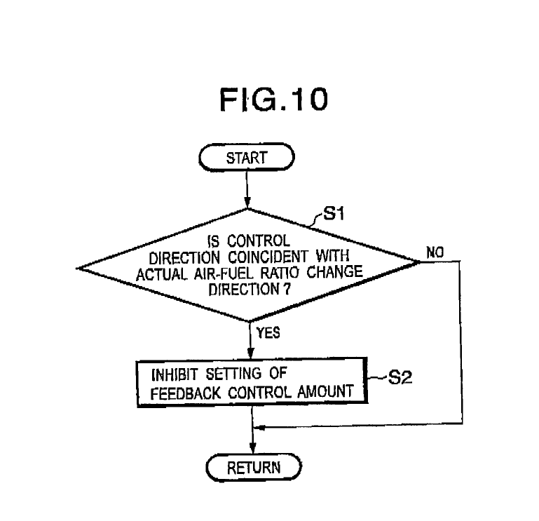

A control executed by second feedback control amount calculation inhibiting section 230 is shown in a flowchart of FIG. 10.

In step 1, it is judged whether or not the control direction is coincident with the change direction of the actual air-fuel ratio.

Specifically, it is judged whether positive/negative of the parameter b₀ (input parameter) of the plant input value matches positive/negative of the parameters a₁, a₂ (output parameters) of the plant output value, in plant model identification section 223. In other words, when the positive/negative of the input parameter b₀ matches the positive/negative of the output parameters a₁, a₂, it is judged that the control direction (an increase/decrease direction of fuel injection quantity) is coincident with the change direction of the actual air-fuel ratio (a rich/lean direction). On the other hand, when the positive/negative of the parameters do not match, it is judged that the control direction is not coincident with the change direction of the actual air-fuel ratio.

Alternatively, it is judged whether the control gain K₁ multiplied to the integral term of switching function σ(t) in the equation representing the feedback control amount u(t) among the control gains calculated at control gain calculating section 224, is positive or negative. When the control gain K₁ is negative, it is judged that the control direction is coincident with the change direction of the actual air-fuel ratio. On the other hand, when positive, it is judged that they are not coincident with each other. This is because as shown in the equation (10), when the fuel injection quantity is controlled to be increased where the change amount Δu(t) of the feedback control amount u(t) is positive, the switching function σ(t) including e(t)=target air-fuel ratio−actual air-fuel ratio should take a negative value, and the control gain K₁ for increasingly correcting the fuel injection quantity should be se to a negative value.

When it is judged in step 1 that the control direction and the change direction of the actual air-fuel ratio are not coincident with each other, the control advances to step 2 where the setting of feedback control amount is inhibited. In this case, the simplest and most direct method is to set each control gain K_{P}, K_{D}, K_{I} and K_{N} to 0. Thereby, the feedback control amount u(t) equals 0.

Alternatively, the values of parameters a₁, a₂ and b₀ are each limited. Specifically, the values of output parameters a₁ and a₂ are reduced (for example, 0), and the value of input parameter b₀ is increased so that the feedback control amount u(t) becomes sufficiently small so as to substantially inhibit the setting.

Or, the values of parameters a₁, a₂ and b₀ may be initialized, to approximate the feedback control amount to 0.

Thus, the feedback control amount setting is inhibited when the control direction of the set feedback control amount (increase/decrease control direction of air-fuel ratio) and the change direction of actual air-fuel ratio do not match due to the deviation of the waste time of from fuel injection valve 5 to A/F sensor 14 from an actual value thereof, so that the feedback control in a wrong direction is prevented and only the feedback control in a right direction is executed. Therefore, the degradation of emission is prevented and convergence of air-fuel ratio to the target value is hastened.

Further, the setting of feedback control amount can be inhibited simply by setting the control gain to 0.

Even further, the setting of feedback control amount by parameters identified in the wrong direction can be prevented by either limiting or initializing the values of the parameters used for the identification.

Moreover, it is possible to easily judge whether or not the control direction of the feedback control amount is coincident with the direction of the actual air-fuel ratio to the target air-fuel ratio, based on the positive/negative of the input parameter and of the output parameters calculated during the identification or on the positive/negative of the control gain.

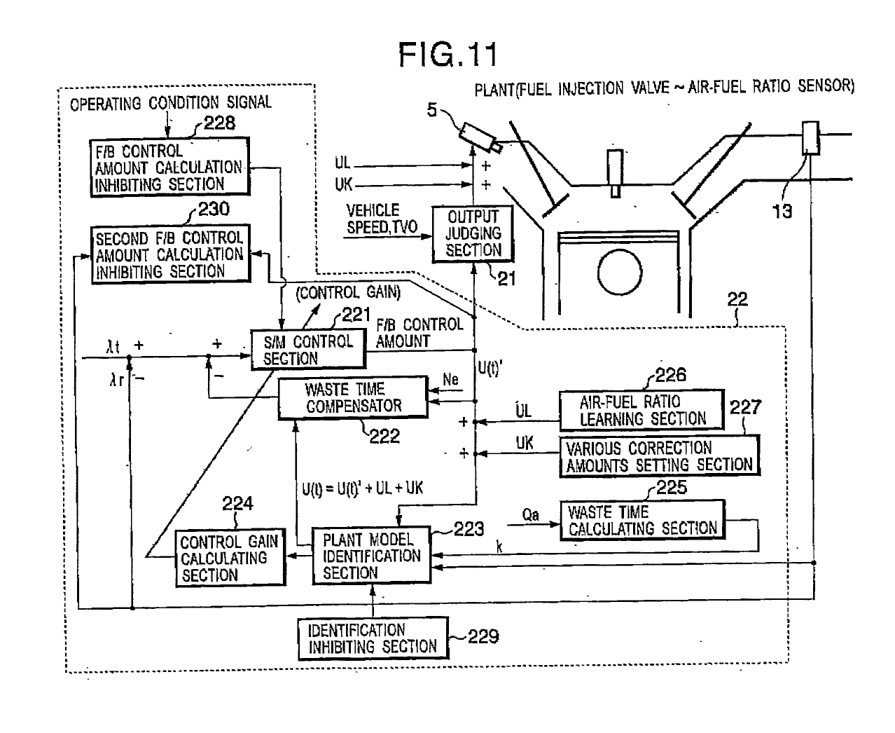

The first to fourth embodiments of the present invention have been described, but the present invention can also be constituted to include all the constitutions of these embodiments to obtain all the effects of the embodiments. FIG. 11 shows the air-fuel ratio control according to a fifth embodiment of the present invention constituted to include all the constitutions.

The entire contents of Japanese Patent Application No. 2001-364371 filed Nov. 29, 2001, Japanese Patent Application No. 2001-371843 filed Dec. 5, 2001, Japanese Patent Application No. 2001-371844 filed Dec. 5, 2001, and Japanese Patent Application No. 2001-371842 filed Dec. 5, 2001, priorities of which are claimed, are incorporated herein by reference.

While only selected embodiments have been chosen to illustrate the present invention, it will be apparent to those skilled in the art from this disclosure that various changes and modifications can be made herein without departing from the scope of the invention as defined in toe appended claims.

Furthermore, the foregoing descriptions of the embodiments according to the present invention are provided for illustration only, and not for the purpose of limiting the invention as defined by the appended claims and their equivalents.

What is claimed is:

1. An air-fuel ratio control apparatus of an internal combustion engine,
said internal combustion engine equipped with a fuel injection valve driven by an air-fuel ratio control signal to inject fuel,
said apparatus comprising:
an air-fuel ratio sensor detecting an actual air-fuel ratio based on an exhaust state; and
a control unit generating the air-fuel ratio control signal including a feedback control amount based on said actual air-fuel ratio at a time when a feedback control is performed, and outputting said air-fuel ratio control signal to said fuel injection valve so that said fuel injection valve injects a fuel amount according to a target air-fuel ratio,
wherein said control unit:
calculates parameters of transfer functions, while sequentially identifying a plant model representing a plant between said fuel injection valve and said air-fuel ratio sensor by said transfer functions;
sets the feedback control amount of said air-fuel ratio control signal using the parameters of the identified plant model;
sets an offset correction amount of said air-fuel ratio control signal; and
identifies said plant model using a value obtained by adding said offset correction amount to said feedback control amount, and said actual air-fuel ratio.

2. An air-fuel ratio control apparatus of an internal combustion engine according to claim 1,
wherein said offset correction amount includes a learning value obtained by learning a deviation of said feedback control amount from a reference value.

3. An air-fuel ratio control apparatus of an internal combustion engine according to claim 1,
wherein said offset correction amount includes various correction values for correcting a basic fuel injection quantity equivalent to the target air-fuel ratio according to operating conditions of the engine.

4. An air-fuel ratio control apparatus of an internal combustion engine according to claim 1,
wherein said feedback control amount is set by sliding mode control using control gains calculated based on said calculated plant model parameters.

5. An air-fuel ratio control apparatus of an internal combustion engine according to claim 1,
wherein said feedback control amount is set by executing a waste time compensation eliminating an effect of waste time included in the plant using said plant model.

6. An air-fuel ratio control apparatus of an internal combustion engine according to claim 1,
wherein said parameters of said plant model are calculated using a recursive least squares method.

7. An air-fuel ratio control apparatus of an internal combustion engine,
said internal combustion engine equipped with a fuel injection valve driven by an air-fuel ratio control signal to inject fuel of an amount according to a target air-fuel ratio,
said apparatus comprising:
an air-fuel ratio sensor detecting an actual air-fuel ratio based on an exhaust state;
identifying means for calculating parameters of transfer functions, while sequentially identifying a plant model representing a plant between the fuel injection valve and the air-fuel ratio sensor by the transfer functions;
feedback control amount setting means for setting the feedback control amount of said air-fuel ratio control signal set based on said actual air-fuel ratio at a time when a feedback control is performed, using the parameters of the identified plant model;
offset correction amount setting means for setting an offset correction amount of said air-fuel ratio control signal; and
data input means for inputting to said identifying means, a value obtained by adding said offset correction amount to said feedback control amount, and said actual air-fuel ratio.

8. An air-fuel ratio control method of an internal combustion engine, comprising the steps of:
calculating parameters of transfer functions, while sequentially identifying a plant model representing a plant between a fuel injection valve driven by an air-fuel ratio control signal to inject fuel of an amount corresponding to a target air-fuel ratio, and an air-fuel ratio sensor detecting an actual air-fuel ratio based on an exhaust state of the engine, by the, transfer functions;
setting the feedback control amount of said air-fuel ratio control signal set based on said actual air-fuel ratio at a time when a feedback control is performed, using the parameters of the identified plant model;
setting an offset correction amount of said air-fuel ratio control signal; and
using a value obtained by adding said offset correction amount to said feedback control amount, and said actual air-fuel ratio, for identifying said plant model.

9. An air-fuel ratio control method of an internal combustion engine according to claim 8,
wherein said offset correction amount includes a learning value obtained by learning a deviation of said feedback control amount from a reference value.

10. An air-fuel ratio control method of an internal combustion engine according to claim 8,
wherein said offset correction amount includes various correction values for correcting a basic fuel injection quantity equivalent to the target air-fuel ratio according to operating conditions of the engine.

11. An air-fuel ratio control method of an internal combustion engine according to claim 8,
wherein said feedback control amount is set by sliding made control using control gains calculated based on said calculated plant model parameters.

12. An air-fuel ratio control method of an internal combustion engine according to claim 8,
wherein said feedback control amount is set by executing a waste time compensation eliminating an effect of waste time included in the plant using said plant model.

13. An air-fuel ratio control method of an internal combustion engine according to claim 8,
wherein said parameters of said plant model are calculated using a recursive least squares method.

14. An air-fuel ratio control apparatus of ark internal combustion engine,
said internal combustion engine equipped with a fuel injection valve driven by an air-fuel ratio control signal to inject fuel,
said apparatus comprising:
an air-fuel ratio sensor detecting an actual air-fuel ratio based on an exhaust state; and
a control unit generating the air-fuel ratio control signal including a feedback control, amount based on said actual air-fuel ratio at a time when a feedback control is performed, and outputting said air-fuel ratio control signal to said fuel injection valve so that said fuel injection valve injects a fuel amount according to a target air-fuel ratio,
wherein said control unit:
calculates parameters of transfer functions, while sequentially identifying a plant model representing a plant between said fuel injection valve and said air-fuel ratio sensor by said transfer functions;
calculates a control gain for calculating said feedback control amount of said air-fuel ratio control signal using the parameters of said identified plant model;
calculates said feedback control amount using the calculated control gain; and
inhibits the calculation of said feedback control amount under a predetermined operating condition other than the time when the feedback control is performed.

15. An air-fuel ratio control apparatus of an internal combustion engine according to claim 14,
wherein said feedback control amount is set by executing a waste time compensation eliminating an effect of waste time included in the plant using said plant model.

16. An air-fuel ratio control apparatus of an internal combustion engine according to claim 14,
wherein said feedback control amount is set so that an initial value is set to an integral term previously set according to operating conditions when the calculation of said feedback control amount is resumed after it has been inhibited.

17. An air-fuel ratio control apparatus of an internal combustion engine according to claim 14,
wherein said feedback control amount is maintained at a set initial value for a predetermined period of time after resuming the calculation of said feedback control amount.

18. An air-fuel ratio control apparatus of an internal combustion engine according to claim 14,
wherein said feedback control amount is calculated by a sliding mode control.

19. An air-fuel ratio control apparatus of an internal combustion engine according to claim 14,
wherein when me calculation of said feedback control amount is inhibited, calculation of said plant model parameters is further inhibited.

20. An air-fuel ratio control apparatus of an internal combustion engine according to claim 19,
wherein when the calculation of said plant model parameters is resumed after it has been inhibited, an initial value previously set according to operating conditions is set as each parameter of said plant model.

21. An air-fuel ratio control apparatus of an internal combustion engine according to claim 20,
wherein said set initial value is maintained for a predetermined period of time after said parameter calculation is resumed.

22. An air-fuel ratio control apparatus of an internal combustion engine according to claim 14,
wherein said plant model parameters are calculated using a recursive least squares method.

23. An air-fuel ratio control apparatus of an internal combustion engine according to claim 14,
wherein an entire system including said plant and said feedback control amount calculation is represented by a transfer function, to calculate said control gain so that said transfer function representing the entire system has a set characteristic.

24. An air-fuel ratio control apparatus of an internal combustion engine according to claim 14,
wherein said predetermined operating condition is a time when fuel is cut off or a time when an open-loop control is performed.

25. An air-fuel ratio control apparatus of an internal combustion engine,
said internal combustion engine equipped with a fuel injection valve driven by an air-fuel ratio control signal to inject fuel of an amount according to a target air-fuel ratio,
said apparatus comprising:
an air-fuel ratio sensor detecting an actual air-fuel ratio based on an exhaust state;
identifying means for calculating parameters of transfer functions, while sequentially identifying a plant model representing a plant between the fuel injection valve and the air-fuel ratio sensor by the transfer functions;
control gain setting means for calculating a control gain for calculating said feedback control amount of said air-fuel ratio control signal set based on said actual air-fuel ratio at a time when a feedback control is performed, using said calculated parameters of said plant model;
feedback control amount setting means for calculating said feedback control amount using the calculated control gain; and
inhibiting means for inhibiting the calculation of said feedback control amount under a predetermined operating condition other than the time when the feedback control is performed.

26. An air-fuel ratio control method of an internal combustion engine, comprising the steps of:
calculating parameters of transfer functions, while sequentially identifying a plant model representing a plant between a fuel injection valve driven by an air-fuel ratio control signal to inject fuel of an amount corresponding to a target air-fuel ratio, and an air-fuel ratio sensor detecting an actual air-fuel ratio based on an exhaust state of the engine, by the transfer functions;
calculating a control gain for calculating said feedback control amount of said air-fuel ratio control signal set based on said actual air-fuel ratio at a time when a feedback control is performed, using said calculated parameters of said plant model;
calculating said feedback control amount using the calculated control gain; and
inhibiting the calculation of said feedback control amount under a predetermined operating condition other than the time when the feedback control is performed.

27. An air-fuel ratio control method of an internal combustion engine according to claim 26,
wherein said feedback control amount is set by executing a waste time compensation eliminating an effect of waste time included in the plant using said plant model.

28. An air-fuel ratio control method of an internal combustion engine according to claim 26,
wherein said feedback control amount is set so that an initial value is set to an integral term previously set according to operating conditions when the calculation of said feedback control amount is resumed after it has been inhibited.

29. An air-fuel ratio control method of an internal combustion engine according to claim 26,
wherein said feedback control amount is maintained at a set initial value for a predetermined period of time after resuming the calculation of said feedback control amount.

30. An air-fuel ratio control method of an internal combustion engine according to claim 26,
wherein said feedback control amount is calculated by a sliding mode control.

31. An air-fuel ratio control method of an internal combustion engine according to claim 26,
wherein when the calculation of said feedback control amount is inhibited, calculation of said plant model parameters is further inhibited.

32. An air-fuel ratio control method of an internal combustion engine according to claim 31,
wherein when the calculation of said plant model parameters is resumed after it has been inhibited, an initial value previously set according to operating conditions is set as each parameter of said plant model.

33. An air-fuel ratio control method of an internal combustion engine according to claim 32,
wherein said set initial value is maintained for a predetermined period of time after said parameter calculation is resumed.

34. An air-fuel ratio control method of an internal combustion engine according to claim 26,
wherein said plant model parameters are calculated using a recursive least squares method.

35. An air-fuel ratio control method of an internal combustion engine according to claim 26,
wherein an entire system including said plant and said feedback control amount calculation is represented by a transfer function, to calculate said control gain so that said transfer function representing the entire system has a set characteristic.

36. An air-fuel ratio control method of an internal combustion engine according to claim 26,
wherein said predetermined operating condition is a time when fuel is cut off or a time when an open-loop control is performed.

37. An air-fuel ratio control apparatus of an internal combustion engine,
said internal combustion engine equipped with a fuel injection valve driven by an air-fuel ratio control signal to inject fuel,
said apparatus comprising:
an air-fuel ratio sensor detecting an actual air-fuel ratio based on an exhaust state; and
a control unit generating the air-fuel ratio control signal including a feedback control amount based on said actual air-fuel ratio at a time when a feedback control is performed, and outputting said air-fuel ratio control signal to said fuel injection valve so that said fuel injection valve injects a fuel amount according to a target air-fuel ratio,
wherein said control unit:
calculates parameters of transfer functions, while sequentially identifying a plant model representing a plant between said fuel injection valve and said air-fuel ratio sensor by said transfer functions;
calculates a control gain for calculating said feedback control amount of said air-fuel ratio control signal using the parameters of said identified plant model;
calculates said feedback control amount using the calculated control gain;
stores said air-fuel ratio control signal value and said actual air-fuel ratio at a time when an open-loop control is performed;
stops the calculation of said plant model parameters at the time when an open-loop control is performed; and
uses said stored air-fuel ratio control signal value and actual air-fuel ratio as input/output data for said plant when the calculation of the plant model parameters is resumed after the open-loop control has been terminated.

38. An air-fuel ratio control apparatus of an internal combustion engine according to claim 37,
wherein said stored air-fuel ratio control signal value and actual air-fuel ratio are used as the input/output data of said plant until a predetermined period of time has elapsed after the calculation of said plant model parameters was resumed.

39. An air-fuel ratio control apparatus of an internal combustion engine according to claim 38,
wherein said predetermined period of time is calculated based on an intake air amount of said engine.

40. An air-fuel ratio control apparatus of an internal combustion engine according to claim 37,
wherein said calculation of the control gain is stopped at the time when the open-loop control is performed.

41. An air-fuel ratio control apparatus of an internal combustion engine according to claim 37,
wherein the calculation of the feedback control amount is stopped at the time when the open-loop control is performed.

42. An air-fuel ratio control apparatus of an internal combustion engine,
said internal combustion engine equipped with a fuel injection valve driven by an air-fuel ratio control signal to inject fuel of an amount according to a target air-fuel ratio,
said apparatus comprising:
an air-fuel ratio sensor detecting an actual air-fuel ratio based on an exhaust state;
identifying means for calculating parameters of transfer functions, while sequentially identifying a plant model representing a plant between the fuel injection valve and the air-fuel ratio sensor by the transfer functions;
control gain setting means for calculating a control gain, for calculating said feedback control amount of said air-fuel ratio control signal set based on said actual air-fuel ratio at a time when a feedback control is performed, using said calculated parameters of said plant model;
feedback control amount setting means for calculating said feedback control amount using the calculated control gain;
storing means for storing said air-fuel ratio control signal value and said actual air-fuel ratio at a time when an open-loop control is performed;
calculation stopping means for stopping the calculation of said plant model parameters at the time when an open-loop control is performed; and
resumption time calculating means for using said stored air-fuel ratio control signal value and actual air-fuel ratio as input/output data for said plant when the calculation of the plant model parameters is resumed after the open-loop control has been terminated.

43. An air-fuel ratio control method of an internal combustion engine, comprising the steps of:
calculating parameters of transfer functions, while sequentially identifying a plant model representing a plant between a fuel injection valve driven by an air-fuel ratio control signal to inject fuel of an amount corresponding to a target air-fuel ratio, and an air-fuel ratio sensor detecting an actual air-fuel ratio based on an exhaust state of the engine, by the transfer functions;
calculating a control gain for calculating said feedback control amount of said air-fuel ratio control signal set based an said actual air-fuel ratio at a time when a feedback control is performed, using said calculated parameters of said plant model;
calculating said feedback control amount using the calculated control gain;
storing said air-fuel ratio control signal value and said actual air-fuel ratio at a time when an open-loop control is performed;
stopping the calculation of said plant model parameters at the time when an open-loop control is performed; and
using said stored air-fuel ratio control signal value and actual air-fuel ratio as input/output data for said plant when the calculation of the plant model parameters is resumed after the open-loop control has been terminated.

44. An air-fuel ratio control method of an internal combustion engine according to claim 43,
wherein said stored air-fuel ratio control signal value and actual air-fuel ratio are used as the input/output data of said plant until a predetermined period of time has elapsed after the calculation of said plant model parameters was resumed.

45. An air-fuel ratio control method of an internal combustion engine according to claim 43,
wherein said predetermined period of time is calculated based on an intake air amount of said engine.

46. An air-fuel ratio control method of an internal combustion engine according to claim 44,
wherein said calculation of the control gain is stopped at the time when the open-loop control is performed.

47. An air-fuel ratio control method of an internal combustion engine according to claim 43,
wherein the calculation of the feedback control amount is stopped at the time when the open-loop control is performed.

48. An air-fuel ratio control apparatus of an internal combustion engine,
said internal combustion engine equipped with a fuel injection valve driven by an air-fuel ratio control signal to inject fuel,
said apparatus comprising:
an air-fuel ratio sensor detecting an actual air-fuel ratio based on an exhaust state; and
a control unit generating the air-fuel ratio control signal including a feedback control amount based on said actual air-fuel ratio at a time when a feedback control is performed, and outputting said air-fuel ratio control signal to said fuel injection valve so that said fuel injection valve injects a fuel amount according to a target air-fuel ratio,
wherein said control unit:
calculates parameters of transfer functions, while sequentially identifying a plant model representing a plant between said fuel injection valve and said air-fuel ratio sensor by said transfer functions;
sets said feedback control amount of the air-fuel ratio control signal by a sliding mode control based on the parameters of the identified plant model;
judges whether or not a control direction of said feedback control amount and a change direction of said actual air-fuel ratio are coincident with each other, and
inhibits the setting of said feedback control amount when said control direction of the feedback control amount and said change direction of the actual air-fuel ratio are not coincident with each other.

49. An air-fuel ratio control apparatus of an internal combustion engine according to claim 48,
wherein a control gain is calculated based on said calculated plant model parameters, said feedback control amount is set by the sliding mode control using said control gain, and said control gain is set to 0, to inhibit the setting of said feedback control amount.

50. An air-fuel ratio control apparatus of an internal combustion engine according to claim 48,
wherein the setting of said feedback control amount is inhibited by limiting values of parameters when identifying said plant model.

51. An air-fuel ratio control apparatus of an internal combustion engine according to claim 48,
wherein the setting of said feedback control amount is inhibited by initializing the values of parameters when identifying said plant model.

52. An air-fuel ratio control apparatus of an internal combustion engine according to claim 48,
wherein it is judged that said control direction of the feedback control amount and a direction to the target air-fuel ratio are not coincident with each other when positive/negative of input parameter and that of output parameter calculated when identifying said plant model do not match.

53. An air-fuel ratio control apparatus of an internal combustion engine according to claim 48,
wherein the control gain is calculated based on said calculated plant model parameters, and said feedback control amount is set by the sliding mode control using said control gain, and
it is judged whether said control direction of the feedback control amount and a direction to the target air-fuel ratio are coincident or not coincident with each other, based on positive/negative of said control gain.

54. An air-fuel ratio control apparatus of an internal combustion engine according to claim 48,
wherein a waste time compensation for eliminating an effect of waste time included in the plant is performed using said plant model when identifying said plant model.

55. An air-fuel ratio control apparatus of an internal combustion engine,
said internal combustion engine equipped with a fuel injection valve driven by an air-fuel ratio control signal to inject fuel of an amount according to a target air-fuel ratio,
said apparatus comprising:
an air-fuel ratio sensor detecting an actual air-fuel ratio based on an exhaust state;
identifying means for calculating parameters of transfer functions, while sequentially identifying a plant model representing a plant between the fuel injection valve and the air-fuel ratio sensor by the transfer functions;
feedback control amount setting means for setting said feedback control amount of the air-fuel ratio control signal by a sliding mode control based on the parameters of the identified plant model;
direction judging means for judging whether or not a control direction of said feedback control amount and a change direction of said actual air-fuel ratio are coincident with each other; and
feedback control amount setting inhibiting means for inhibiting the setting of said feedback control amount when said control direction of the feedback control amount and said change direction of the actual air-fuel ratio are not coincident with each other.

56. An air-fuel ratio control method of an internal combustion engine, comprising the steps of:
calculating parameters of transfer functions, while sequentially identifying a plant model representing a plant between a fuel injection valve driven by an air-fuel ratio control signal to inject fuel of an amount corresponding to a target air-fuel ratio, and an air-fuel ratio sensor detecting an actual air-fuel ratio based on an exhaust state of the engine, by the transfer functions;
setting said feedback control amount of the air-fuel ratio control signal set based on said actual air-fuel ratio at a time when a feedback control is performed, by a sliding mode control based on the parameters of the identified plant model;
judging whether or not a control direction of said feedback control amount and a change direction of said actual air-fuel ratio are coincident with each other; and
inhibiting the setting of said feedback control amount when said control direction of the feedback control amount and said change direction of the actual air-fuel ratio are not coincident with each other.

57. An air-fuel ratio control method of an internal combustion engine according to claim 56,
wherein a control gain is calculated based on said calculated plant model parameters, said feedback control amount is set by the sliding mode control using said control gain, and said control gain is set to 0, to inhibit the setting of said feedback control amount.

58. An air-fuel ratio control method of an internal combustion engine according to claim 56,
wherein the setting of said feedback control amount is inhibited by limiting values of parameters when identifying said plant model.

59. An air-fuel ratio control method of an internal combustion engine according to claim 56,
wherein the setting of said feedback control amount is inhibited by initializing the values of parameters when identifying said plant model.

60. An air-fuel ratio control method of an internal combustion engine according to claim 56,
wherein it is judged that said control direction of the feedback control amount and a direction to the target air-fuel ratio are not coincident with each other when positive/negative of input parameter and that of output parameter calculated when identifying said plant model do not match.

61. An air-fuel ratio control method of an internal combustion engine according to claim 56,
wherein the control gain is calculated based on said calculated plant model parameters, and said feedback control amount is set by the sliding mode control using said control gain, and
it is judged whether said control direction of the feedback control amount and a direction to the target air-fuel ratio are coincident or not coincident with each other, based on positive/negative of said control gain.

62. An air-fuel ratio control method of an internal combustion engine according to claim 56,
wherein a waste time compensation for eliminating an effect of waste time included in the plant is performed using said plant model when identifying said plant model.
